(19) United States
(12) Patent Application Publication
(10) Pub. No.: US 2017/0341193 A1
(43) Pub. Date: Nov. 30, 2017

(54) Operator-friendly Dead-length Quick-set Workholding Collet & Chuck Docking Station

(71) Applicant: Mike Bonilla Lopez, Whittier, CA (US)

(72) Inventor: Mike Bonilla Lopez, Whittier, CA (US)

(73) Assignee: Electric Motor & Actuator Technologies LLC, Fontana, CA (US)

(21) Appl. No.: 15/168,188

(22) Filed: May 30, 2016

(51) Int. Cl. B23Q 3/06

(52) U.S. Cl. CPC B23Q 3/067; B23Q 2703/08

(57) ABSTRACT

A n operator-friendly dead-length workholding collet and chuck docking station comprises a core body, a collet and chuck, or plurality of collets and chucks, a quick-set. failsafe actuation mechanism, a coolant bleed channel or plurality of coolant bleed channels, and workholding coordinate system axes markers. The docking station contains pro visions for vertical or horizontal mounting in milling machines or machine centers and accepts standard and emergency collets wherein workpieces may be inserted, held in place, and machined.

### CROSS-REFERENCE TO RELATED APPLICATIONS

Not Applicable

### FEDERALLY FUNDED RESEARCH

Not Applicable

### SEQUENCE LISTING OR OTHER PROGRAM

Not Applicable

### BACKGROUND OF THE INVENTION

### Field of Invention

The present invention relates to workholding clamping assemblies (hereinafter referred to as workholders) such as those used, for example, in the metal working or wood working industries, and particularly to a class of workholder referred to as a dead length collet chuck assembly with a quick action collet lock, reinvented to include new innovations that facilitate and improve usage.

### Prior Art

The development of collet chuck assemblies, or workholders, used for holding a workpiece, for the purpose of machining it, is an ongoing work-in-progress. A typical assembly comprises a collet, used to secure the workpiece in a fixed position; a chuck, or sleeve, used to damp the collet around the workpiece; and sundry co-operational devices or components that serve to actuate the chuck or the collet, slidably, relative to each other, along a common longitudinal axis, and/or to allow integration into host machines, and/or to house or provide a support structure for the collet and the chuck. The chuck and collet are generally components shaped like hollow cylinders, each possessing an outside diameter surface, an inside diameter surface, a discrete length, and a common longitudinal axis. The collet contains a plurality of longitudinal slots, located circumferentially and funning a plurality of leaves, and rests concentrically within the chuck. The principle of operation may involve actuation of the chuck, slidably along the common axis, to produce movement of the chuck, relative to the collet, or vice-versa. The chuck contains a conically shaped inner surface at the end of the chuck that is in proximity with a co-operationally conically shaped outer surface at one end of the collet. When either the chuck or the collet is actuated along the common axis, so that the conical surface of the chuck first comes into contact with and then presses against the conical surface of the collet, the chuck radially compresses the slotted collet, thereby circumferentially closing the collet around a mounted workpiece. The workpiece is thereby accordingly clamped in place, for the machining operation. Analogously, actuation in the opposite longitudinal direction causes a relaxation of the chuck, over the collet. The workpiece is loosened, enabling its removal. Prior art is replete with inventions relating to the manner and intricacies in which the workholder is configured and actuated, and the benefits thereof.

U.S. Pat. No. 3,055,671 to Lewis, et al (1962). describes a tool or work holder of the collet chuck type. Isometric and cross-section views of the holder are depicted in FIGS. 1A and 1B, respectively. Said holder comprises a stationary chuck body 1, a collect 2, and a common axis 3. The collet 2 is slidably moved, or actuated, relative to the chuck body 1, along said common axis 3, to clamp a workpiece 4 in place. When clamped, said workpiece 4 is held along an inner tool- or work-engaging surface 5, mechanically configured to accept the co-operationally mechanically configured workpiece 4. In the case of the holder depicted in FIG. 1, the work-engaging surface 5 is cylindrically shaped to accommodate a cylindrically shaped workpiece clamp surface 6. One of the major conveniences allowed by Lewis's invention is a fast action indexing capability whereby a workpiece can be loaded and unloaded quickly, via a manually operated lever 7, however, this type of assembly produces variation across a plurality of serially-worked like workpieces, in the resting position of each clamped workpiece, along the common axis 3 of the chuck body 1 and collet 2. The primary factor contributing to the resultant position variation is variability in the diameters of the workpieces. Workpieces with diameters at the high end of the tolerance band will cause the actuated collet to clamp at an axial position of minimum travel between the collet and the chuck. Conversely, workpieces with diameters at the low end of the tolerance band will clamp at an axial position of maximum relative travel. Additionally, the actuation mechanism involves numerous components and interlocks; and the workholder is of stand-alone configuration—that is, it contains no provisions for mounting onto machine tools. Nevertheless, the invention facilitated workpiece clamping and reduced changeover time.

A flurry of improvements to the Lewis, et al. invention has ensued. U.S. Pat. No. 3,292,939 to K. H. Lorenz (1966), augments the prior art with collet and chuck workholders that reverse the relative actuation between the chuck and the collet, so that the collet position is fixed and the chuck slidably moves, relative to the collet—a major advantage over Lewis's invention. Lorenz's workholder, however, is a complex assembly comprising a myriad of components. The key components include a stationary collect, a chuck body, a common axis, and a chuck body mounting disc, used to mount the chuck body to a lathe spindle face plate fastened at the end of a lathe spindle.

In Lorenz's mechanism, a plurality of serially-machined like workpieces, regardless of the variation in the diameter of each piece, can each be loaded to rest in the same axial position of the workholder. Workholders that possess this feature may be referred to as “true length,” “dead length,” or “dead stop” assemblies. Lorenz's invention also includes a means to mount the workholder onto machine tools, facilitating support of the workpiece relative to the cutting tool, during the cutting operation—another advantage, compared to Lewis's design.

An elegantly simple method of actuating a chuck, relative to a stationary collet, may be found in U.S. Pat. No. 4,218,165 to V. M. Riddersholm (1980). The invention described therein significantly reduced the number of components that were typically used in the actuation mechanism. FIG. 2 depicts isometric and cross-section views of Riddersholm's invention. In this invention, a workholder uses only four components to actuate a collet: 1) a manually operated wrench 8; 2) an integral eccentric key 9; 3) a ring 10; and 4) an annular member 11. Said ring 10 co-operationally with said annular member 11 secure the collet 2 with collet teases 12, within the chuck body 1 in a fixed axial or longitudinal position. According to Riddersholm, the invention “permits rapid opening and closing of the collet leaves by simple rotation of a key located in the chuck itself. The key not only opens and closes the collet but locks the collet in both the open and closed positions,” i.e., thereby preventing accidental loosening of a workpiece during machining—a condition typically referred to as—“failsafe.” Riddersholm further contends that the lock relics on a preferred line of contact between the eccentric key and the key receptacle slot in the chuck and is forgiving of slight offsets from said line of contact, since any rotational forces applied to the eccentric key, during a machining operation, for example, “would be applied through a relatively small moment arm.” It can be argued, however, that this type of system is not completely failsafe but, rather, quasi-failsafe.

Still another invention, described in U.S. Pat. No. 7,971,883 B2 to Soroka et al (2011), further advanced the state of collet and chuck workholding technology through a new, fully failsafe operation mechanism and through a mechanical configuration whereby a plurality of workholders and workpieces may be mounted to a pallet or subframe and may be easily and conveniently transported between machining centers. FIG. 3 depicts a pallet 13 and three workholders 14 that have been mounted onto it. Each workholder contains a different type of collet: an emergency step collet 15, a standard 5C collet 16, and an inside diameter collet 17. Key features of this invention, then, appear to involve workholder portability and a fully failsafe actuation mechanism, designed for automated clamping systems that utilize, for example, pressurized fluid to apply an unclamping force that is greater than the force exerted by a mechanical driver that otherwise forces the collet to a sale, clamped default state upon a power loss condition.

A state-of-the-art workholder can therefore be considered to include, at a minimum: 1) Lorenz's dead length workpiece positioning feature, whereby the chuck moves slidably, relative to a stationary collet, thereby ensuring position repeatability in clamped, like-workpieces: 2) a highly reliable, yet simplistic Riddersholm-type, low component-count actuation mechanism; and 3) relative to the Soroka, et al. invention, a) a simpler sort of failsafe mechanism designed for use in manually-clamped systems, eliminating the need for Soroka's mechanical driver—required to “failsafe” the workholder to the clamped slate upon a power loss condition; and eliminating the need for the force amplification required to offset the force of the driver whenever the workholder must be in an unclamped state, and b) a configuration whereby a plurality of workholders are not mounted to a pallet or subframe but, rather, integrated into a core body, thereby forming a multi-port chuck and collet docking station—two conveniences that would facilitate usage and mitigate operator error. There are additional features, however, that can be incorporated to further facilitate usage of these devices, thereby improving reliability, while making the life of the operator easier.

Any person who has ever worked around cutting machines and the like, can vouch for the fact that coolants—used for the dual purpose of cooling a workpiece and providing cutting lubricity—are a pain to remove from a workholder and can make retrieval of a machined workpiece a particularly messy operation. They also contain filings generated during the machining operation—filings that can become lodged between the workholder and a subsequently machined workpiece. A state-of-the-art workholder collet and chuck docking station would therefore also include a mechanism to allow coolant to drain, or bleed, off of said docking station and machined workpiece(s), when mounted to a machine, machining center, or any other coolant source, to mitigate coolant buildup and enable cleaner retrieval of a workpiece.

Yet another operation that can be painstaking is the mounting of workholders to machines or machining centers such that the workholder axes are aligned, or synchronized, with the coordinate axes system of the machine. A state-of-the-art collet and chuck docking station would therefore also include axes markers that could be used to easily and accurately align said station, within the machine in which it is being used.

Coolant bleed channels and axes markers are key features not found in prior art. The present invention comprises these innovations and a simple poka yoked failsafe mechanism and packages them into existing workholder technology. In fact, the workholder models that the present invention builds upon are 5C Collet Fixture, 225-202C, commercially available throughout the U.S., and single and multi-station fixtures manufactured by Rovi Products Inc., of Simi Valley, Calif. 93063—both based on prior art that has run its course.

### Objects and Advantages

Accordingly, objects and advantages of the present invention are: To provide a state-of-the-art utilitarian single-port or multi-port collet and chuck workholder, or docking station, that builds upon some of the more practical and desirable features of the present state of workholder technology, through incorporation of new innovations that improve and facilitate usage: namely: coolant bleed channels, axes markers, and a simple failsafe actuation mechanism that may be visually poka yoked to mitigate operator error and used in non-automated clamping systems.

### SUMMARY

In accordance with the present invention a workholder collet and chuck docking station with a single set of workpiece holder stationary collet and slidable chuck or with a plurality of sets of workpiece holder stationary collets and slidable chucks employs a simple failsafe actuation mechanism innovation that may be visually poka yoked to mitigate operator error. It also incorporates coolant bleed channels to mitigate coolant and debris buildup and enable cleaner retrieval of a workpiece or plurality of workpieces; and axes markers used to easily and accurately align the workholder with the coordinate system of the machine in which it is being used.

### BRIEF DESCRIPTIONS Or THE SEVERAL VIEWS OF THE DRAWINGS

In the drawings, closely related figures have the same number but different alphabetic suffixes.

FIGS. 1A and 1B are isometric and conventional views, respectively, of a workholder assembly comprising a stationary chuck body 1 and a collet 2 that is slidably movable, relative to said chuck body 1, along common axis 3. The work holder also comprises an operator lever 7, integrated into said assembly in such a manner that rotation of said lever 7 about said axis 3 causes the slidable movement of said collet 2, along axis 3. FIG. 1B, Section AA depicts a workpiece 4, clamped within collet 2, whereby work-engaging surface 5, depicted in FIG. 1A, is in contact with workpiece clamp surface 6, depicted in FIG. 1B.

FIGS. 2A and 2B are isometric and conventional views, respectively, of a workholder assembly comprising a chuck body 1 that is slidably movable, relative to a stationary collet 2, along common axis 3. The workholder comprises an actuation mechanism whereby a manually operated wrench 8 engaged in an eccentric key 9, drives a ring 10 and annular member 11 that co-operationally effect actuation of the workholder to constrict collet leaves 12, thereby clamping and holding a workpiece in place.

FIG. 3 depicts an isometric view of a portable pallet 13 onto which have been mounted a plurality of workholders 14, each of which has been loaded with a unique type of collet; namely: an emergency step collet 15, a standard 5C collet 16, and an inside diameter collet 17.

FIG. 4A illustrates top, side, and isometric views of a preferred embodiment of a 5-port state-of-the-art collet and chuck docking station. FIGS. 4B and 4C illustrate cross-sectional views of the docking station. The docking station comprises a station body 18; a plurality of cylindrically-shaped chuck 1 and collet 2 sets, paired along common axis 3; a plurality of cammed key 9 and operator handle 19 sets, paired along common axis 20; a plurality of failsafe locking provision 21 and failsafe pin 22 sets, paired along common axis 23; a plurality of coolant bleed channels 24; a plurality of station-body ports 25; and workspace X-coordinate marker 26 and Y-coordinate marker 27; plus, mounting bolt holes 28; pluralities of set screws 29 and 30; and pluralities of fastener 31.

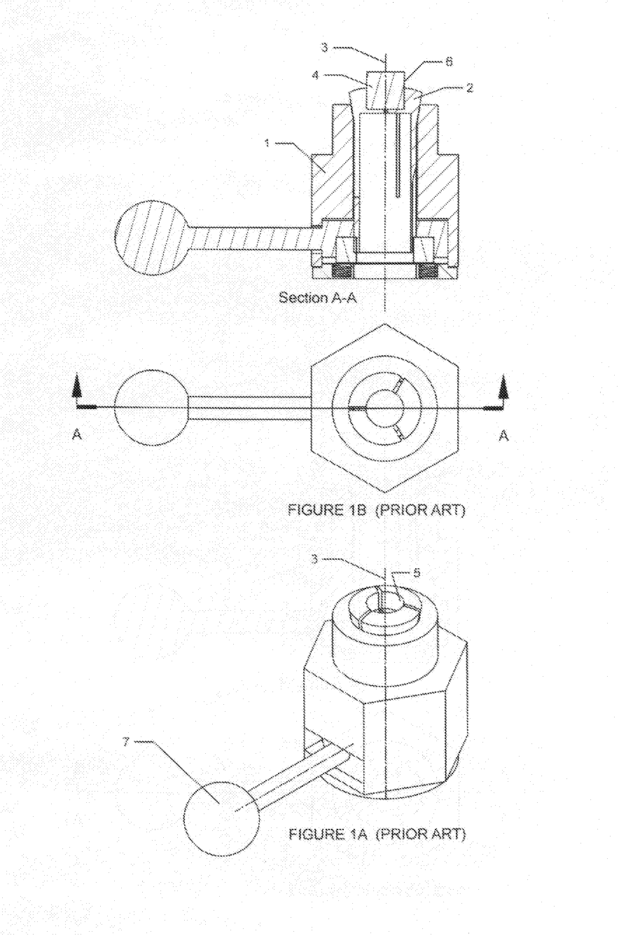

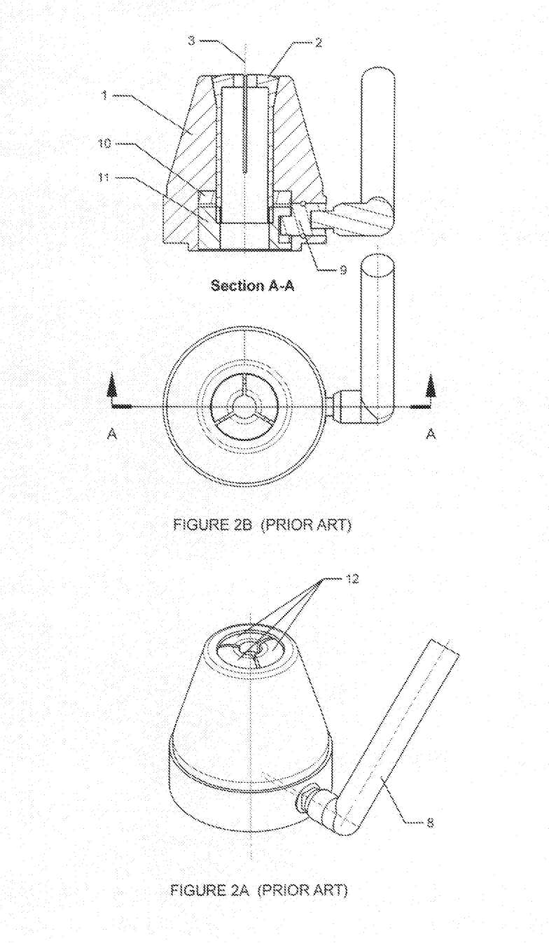

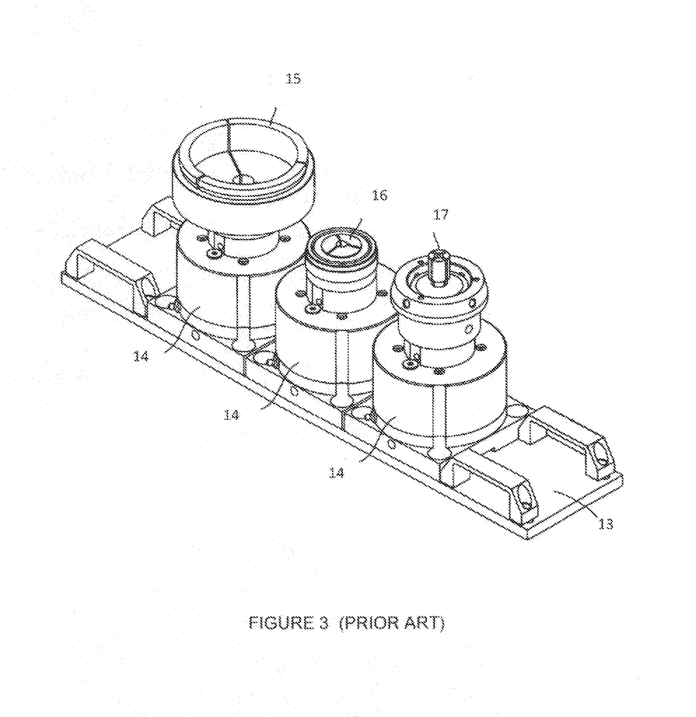

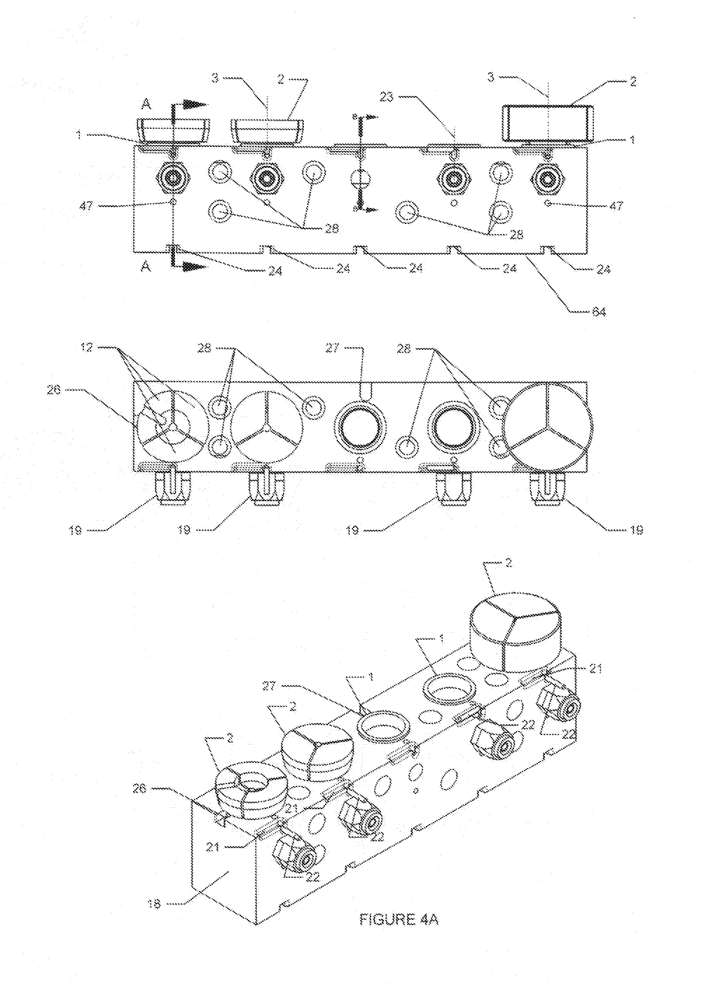

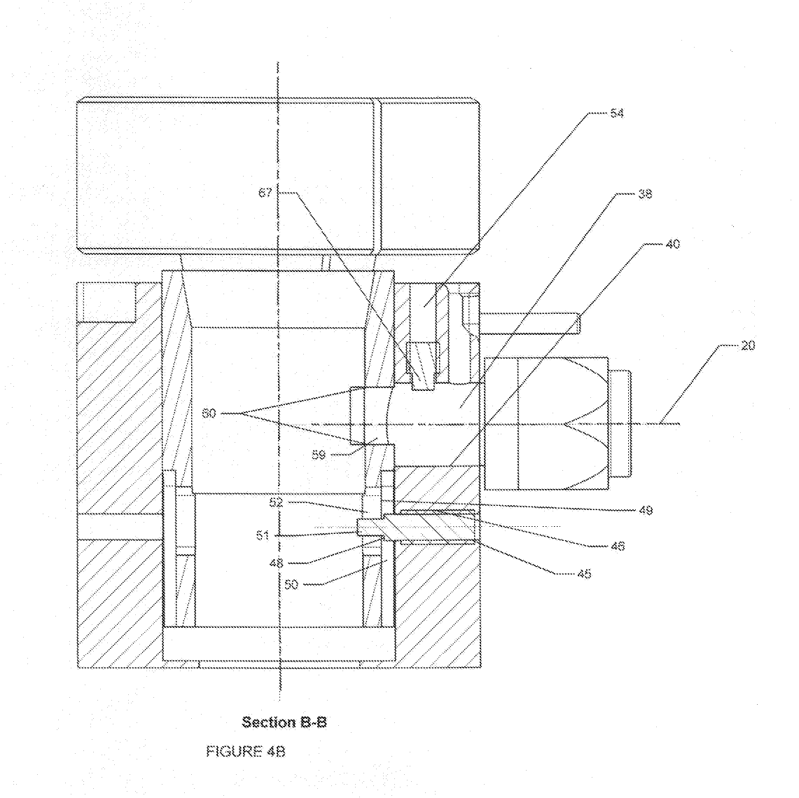

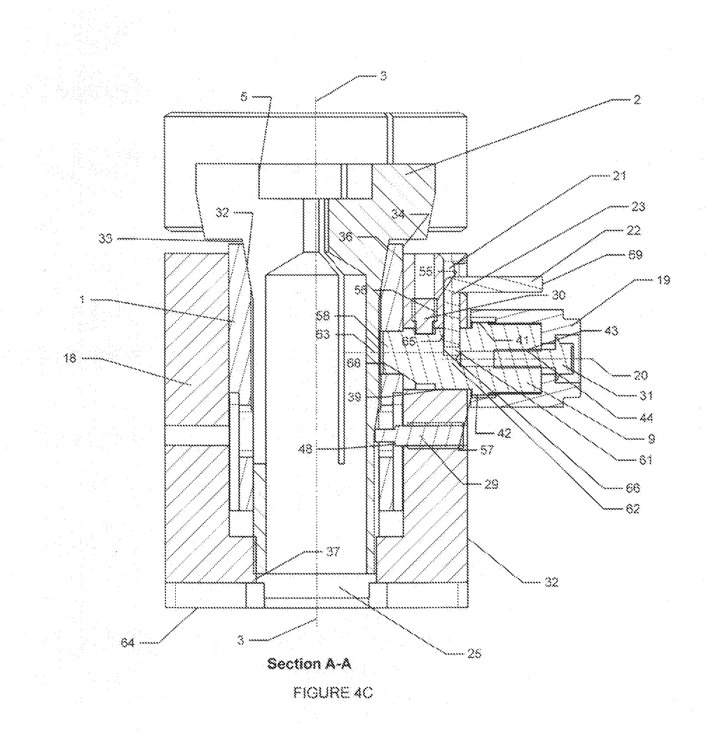

### DETAILED DESCRIPTION—FIGS. 4A, 4B and 4C—PREFERRED EMBODIMENT

A preferred embodiment of a state-of-the-art collet and chuck docking station featuring integration of the elements of the present invention is illustrated in FIGS. 4A (assembly) and 4B & 4C (cross-sectional views). The major components the docking station comprises include a station body 18 and a plurality of cylindrically-shaped chuck 1 and collet 2 sets, paired along common axis 3. In the preferred embodiment, each collet 2 rests within one chuck 1, along common axis 3, whereby a conically-shaped inner surface 32 extending out from the inner diameter of each said chuck 1 is adjacent to a co-operationally conically-shaped outer surface 33 extending out from the outer diameter of each said collet 2. Additionally, each said chuck 1 rests within one station-body port 25, along common axis 3, whereby a cylindrically-shaped smooth outer surface 34 and threaded outer surface 35 along the outer diameter of each said collet 2 are adjacent to a co-operationally cylindrically-shaped smooth inner surface 36 and threaded inner surface 37, respectively, along the inner diameter of each said port 25.

The preferred embodiment of a state-of-the-art docking station also comprises a plurality of cammed key 9 and operator handle 19 sets, paired along common axis 20; a plurality of failsafe locking provision 21 and failsafe pin 22 sets, paired along common axis 23; a plurality of coolant bleed channels 24; a plurality of station-body ports 25; and workspace X-coordinate marker 26 and Y-coordinate marker 27; plus, mounting bolt holes 28; pluralities of set screws 29 and 30; and pluralities of fastener 31. Each cammed key 9 rests within one member of a plurality of key bores 38, along common axis 20, such that a cylindrically-shaped outer surface 39 along the outer diameter of said cammed key 9 is adjacent to a go-operationally cylindrically-shaped inner surface 40 along the inner diameter of said key bore 38. Additionally, each member of a plurality of operator handles 19 rests over a unique cammed key 9, along common axis 20, such that the toothed inner surface 41 along the inner diameter of said operator handle 19 is adjacent to a co-operationally-toothed outer surface 42 along the outer diameter of said cammed key 9, Each said operator handle 19 and cammed key 9 is held together with fastener 31, whereby threaded outer surface 43 along an outer diameter of said fastener 31 is adjacent and engaged to a co-operationally-threaded inner surface 44 along an inner diameter of cammed key 9.

Chuck 1 and collet 2 are simultaneously secured against rotation along common axis 3 via set screw 29, wherein threaded outer surface 45 along the outer diameter of said set screw 29 is adjacent to a co-operationally-threaded inner surface 46 along the inside diameter of bore 47. Flat surface 48 of set screw 29 rests adjacent to edge 49 of vertical collet slot 50 of width slightly greater than the outer diameter of said threaded outer surface 45. A cylindrically-shaped tip 51 at the end of set screw 29 with outer diameter of size less than the outer diameter of said outer surface 45 rests within a vertically-oriented chuck slot 52 of width slightly greater than the outer diameter of said tip 51. The widths of said vertical collet slot 50 and vertical chuck slot 52 are centered around set screw axis 53.

Cammed key 9 is secured against movement along axis 20 via set screw 30. Said set screw 30 rests within bore 54 and has a threaded outer surface 55 along the outer diameter of said set screw 30 which is adjacent to a co-operationally-threaded inner surface 56 along the inside diameter of said bore 54. A cylindrically-shaped tip 67 at the end of said set screw 30 with outer diameter of size slightly less than the axial width-, and length slightly greater than the radial depth of circumferential key channel 68 co-operationally engages with said key channel 68. Each said set screw 30 thereby locates surface 57 of said cammed key 9 relative to outer surface 32 of station body 18 and secures it against movement along said common axis 20.

Each cammed key 9, however, is generally free to rotate about its axis 20. It comprises a cylindrically-shaped tip 58, along axis 63, whereby said axis 63 is offset from said axis 20, such that said tip 58 is eccentrically oriented, relative to said cammed key 9. Said lip 58 is located at the end of the cylindrically-shaped outer surface 39, opposite surface 57 of said cammed key 9. Said tip 58 rests within horizontal slot 59 of collet 2, bounded by two horizontal slot surfaces 60. The vertical distance between said horizontal slot surfaces 60 is slightly greater than the outer diameter of said lip 58. Each cammed key 9 also contains a cylindrically-shaped hole 61 along axis 62 simultaneously orthogonal to and intersecting said axis 63 of said tip 58 and axis 20 of said cammed key 9, and extending to a depth just above said axis 20.

In every case, when an outer surface on an outer diameter of one of the components that the docking station comprises rests adjacently to the inner surface on an inner diameter of another comprised component, the outer surface of the first component is always configured so that the diameter is slightly less than the diameter of the inner surface of the adjacent component. Thus, for example, when collet 2 is fitted into chuck 1, configured as shown in FIG. 4C, said chuck 1 may move slidably and freely, relative to said collet 2, along common axis 3.

From FIGS. 4A, 4B and 4C, it can be seen that each set screw 29, in combination with the engagement between threaded outer surface 35 of collet 2 and threaded inner surface 37 of station-body port 25, prevents angular or linear displacement of said collet 2, about or along axis 3, thereby enabling a true-length operational feature of the docking station. It can also be seen that rotation of cammed key 9 about axis 20, to a position such that hole 61 is adjacent to failsafe locking provision 21, and axis 62 of said hole 61 is coincident with axis 23 of said failsafe locking provision 21 enables two operational objectives of the docking station: 1) chuck 1 may be moved slidably up along said axis 3, away from the bottom surface 64 of the docking station, resulting in radial compression of collet leaves 12 and a clamped workpiece, and 2) insertion of failsafe pin 22—with outer surface 65 along the outer diameter of said failsafe pin 22 adjacent to inner surface 66 along the inner diameter of said hole 61—into hole 61, thereby effecting the failsafe operational feature. Furthermore, said failsafe pin 22 can only engage said hole 61 when surface 69 at the end of said pin 22 is parallel to surface 32 of station body 18, thereby providing a poka yoked, visual verification element to the failsafe operational feature of the docking station.

### Advantages

From the description above, a number of advantages of the chuck and collet docking station with dead length workholding configuration, coolant bleed channels, machine center mounting provisions and X and Y coordinate markers, and poka yoked failsafe provisions become evident:
1) A plurality of to-be-machined workpieces, regardless of the variation in the diameter of each piece, can each be serially loaded to rest in the same axial position of a specific workholder, enabling a number of machining center operational process and handling benefits—
   a. No need to measure and record the unique diameters of a plurality of like components that are to be serially loaded into and machined on a common workholder;
   b. No need to calculate unique machine offsets corresponding to unique diameters of a plurality of like components that are to be serially loaded into and machined on a common workholder;
   c. No need to set on machining centers unique machine offsets required to compensate for the part-to-part variability observed in the unique diameters of a plurality of like components that are to be serially loaded into and machined on a common workholder; and
   d. No need to reset to default values the unique machining center offsets that were set while machining a plurality of like components that will have been serially loaded into and machined on a common workholder.
2) A plurality of emergency collets utilized in said docking station may be machined such that a plurality of to-be-machined like workpieces, regardless of the variation in the diameter of each piece, can each be loaded to rest in the same axial position of any workholder the docking station comprises, enabling the same machining center operational process and handling benefits outlined in 1), above, and more—
   a. No need to measure and record the unique diameters of a plurality of like components that are to be loaded—in series or in parallel—into and machined on any workholder the docking station comprises;
   b. No need to calculate unique machine offsets corresponding to unique diameters of a plurality of like components that are to be loaded—in series or in parallel—into and machined on any workholder the docking station comprises;
   c. No need to set on machining centers unique machine offsets required to compensate for the part-to-part variability observed in the unique diameters of a plurality of like components that are to be loaded—in series or in parallel—into and machined on any workholder the docking station comprises;
   d. No need to reset to default values the unique machining center diameter offsets that were set while machining a plurality of like components that will have been loaded—in series or in parallel—into and machined on any workholder the docking station comprises;
   e. No need to measure and record the unique heights of a plurality of like workholders that the docking station comprises;
   f. No need to calculate unique machine offsets corresponding to the unique heights of a plurality of like workholders that the docking station comprises;
   g. No need to set on machining centers unique machine offsets required to compensate for the unique heights of a plurality of like workholders that the docking station comprises;
   h. No need to reset to default values unique machining center height offsets that were set while machining a plurality of workholders that the docking station comprises.
3) Bleed channels facilitate coolant draining, or bleeding, off of the docking station and machined workpiece(s), minimizing the amount of residual coolant and filings in close proximity with workholders and workpieces, subsequent to any machining operation that requires coolant usage—
   a. Limiting the time and energy needed to clean the workpiece and workholder; and
   b. Mitigating mechanical variations caused by inadvertent entrapment in clamped workpieces of filings generated from workpieces previously clamped and machined in the same workholder.
4) Mounting provisions and X & Y coordinate markers facilitate the mounting of the docking station onto a machining center or a machining center adaptor plate, and alignment to the X & Y workspace origins of the center—
   a. Limiting the machine and workstation setup time requirement;
   b. Enabling extrapolation of workspace coordinates across all workholders comprised in a docking station.
5) A simple, poka yoked failsafe mechanism designed for use in manually-clamped systems—
   a. No need for a mechanical driver, such as those invented for automated systems, to “failsafe” the workholder to the clamped state upon a power loss condition; nor for the force amplification required to offset the force of the driver whenever the workholder is in an unclamped state;
   b. Provides a visual indicator of the failsafe state of the system;
   c. Prevents inadvertent damage to the failsafe mechanism by setting a mechanical impediment to actuation of the mechanism, when set.

### CONCLUSIONS, RAMIFICATIONS, AND SCOPE

Accordingly, the reader will see that a docking station configured as illustrated in FIGS. 4A, 4B, & 4C will possess a dead length clamping attribute, coolant bleed channels, X and Y machining center workspace coordinate registration markers, and a poka yoked failsafe clamping mechanism.

Although the description above contains many specifications, these should not be construed as limiting the scope of the invention but merely providing illustrations of some of the presently preferred embodiments of this invention. For example, the docking station: may or may not be of dead length configuration; may comprise a single workholder or a plurality of workholders, single bleed channels or a plurality of bleed channels; linear bleed channels or bleed channels shaped to complement any special orientation of workholders, connecting in one mechanical configuration or in a plurality of configurations; may comprise a manually-actuated failsafe clamping mechanism that may or may not be poka yoked to indicate the state of operation; may comprise collets of different shapes and sizes; may comprise one or more, or a combination or permutation thereof, of any of the foregoing elements, etc.

Thus the scope of the invention should be determined by the appended claims and their legal equivalents, rather than by the examples given.

We Claim:

1. An assembly comprising elements that conventional workholders comprise, including a chuck body, a slidable chuck, a stationary collet, an eccentrically-cammed key, an operator handle, and securing set screws; improved for operator-friendly usage, wherein those improvements comprise:
a) A coolant bleed channel;
b) X and Y axis machining center workspace registration markers;
c) A failsafe mechanism that does not need force amplification to release it from the failsafe state and which can be poka yoked to indicate the failsafe status;
d) A coolant bleed channel and X and Y axis machining center workspace registration markers;
e) A coolant bleed channel and a failsafe mechanism that docs not need force amplification to release it front the failsafe state and which can be poka yoked to indicate the failsafe status; and
f) X and Y axis machining center workspace registration markers and a failsafe mechanism that does not need force amplification to release it from the failsafe state and which can be poka yoked to indicate the failsafe status; and
g) A coolant bleed channel. X and Y axis machining center workspace registration markers, and a failsafe mechanism that does not need force amplification to release it from the failsafe state and which can be poka yoked to indicate the failsafe status.

2. An assembly comprising elements that conventional workholders comprise, including a chuck body, a plurality of slidable chucks, a plurality of stationary collets, a plurality of eccentrically-cammed keys, a plurality of operator handles, and a plurality of securing set screws, improved for operator-friendly usage, wherein those improvements comprise:
a) A plurality of coolant bleed channels;
b) X and Y axis machining center workspace registration markers;
c) A failsafe mechanism that docs not need force amplification to release it from the failsafe state and which can be poka yoked to indicate the failsafe status;
d) A plurality of coolant bleed channels and X and Y axis machining center workspace registration markers;
e) A plurality of coolant bleed channels and a failsafe mechanism that does not need force amplification to release it front the failsafe state and which can be poka yoked to indicate the failsafe status;
f) X and Y axis machining center workspace registration markers and a failsafe mechanism that does not need force amplification to release it from the failsafe state and which can be poka yoked to indicate the failsafe status; and
g) A plurality of coolant bleed channels, X and Y axis machining center workspace registration markers, and a failsafe mechanism that does not need force amplification to release it from the failsafe state and which can be poka yoked to indicate the failsafe status.
